(19) United States
(12) Patent Application Publication
(10) Pub. No.: US 2015/0281121 A1
(43) Pub. Date: Oct. 1, 2015

(54) TRANSMITTER, TRANSMISSION SYSTEM, AND RECORDING MEDIUM

(71) Applicant: FUJITSU LIMITED, Kawasaki-shi (JP)

(72) Inventors: Hiroshi Fukaya, Chikusei (JP); SHIGEO HANDA, Moka (JP); TOSHIYUKI SAKAMOTO, Yuki (JP)

(21) Appl. No.: 14/633,780

(22) Filed: Feb. 27, 2015

(30) Foreign Application Priority Data
Mar. 27, 2014 (JP) 2014-066972

(51) Int. Cl. H04L 12/927; H04L 12/833

(52) U.S. Cl. CPC H04L 47/805; H04L 47/2458

(57) ABSTRACT

A transmitter includes an allocating unit, a determining unit and a control unit. The allocating unit allocates, based on priorities of a first signal and a second signal received by a single port in the transmitter, a band of the port to a signal having a higher priority. The determining unit determines whether a local port in the transmitter or a destination of the local port uses the first signal as a standby signal in a redundant configuration. The control unit changes, when the determining unit determines that the local port or the destination uses the first signal as the standby signal, the priority of the second signal received by the local port such that the priority of the second signal is higher than the priority of the first signal.

### CROSS-REFERENCE TO RELATED APPLICATION

This application is based upon and claims the benefit of priority of the prior Japanese Patent Application No. 2014-066972, filed on Mar. 27, 2014, the entire contents of which are incorporated herein by reference.

### FIELD

The embodiment discussed herein is related to a transmitter, a transmission system, and a recording medium.

### BACKGROUND

In communication networks, such as broadband Ethernet (registered trademark), a physical path is shared by a plurality of signals to provide various types of services. Examples of the services include a bandwidth guarantee service using a redundant path and a best effort service that allows signal loss. Examples of communication systems include a multicast system and a broadcast system using multipoint-to-multipoint (mp2mp) signals and a unicast system using peer-to-peer (p2p) signals.

Recent communication networks more frequently distribute signals with the broadcast and multicast systems than with the unicast system. In the signal distribution with the broadcast and multicast systems, it is expected to effectively use an available band of a redundant path.

Communication networks in which a plurality of paths are made redundant employ the spanning tree protocol (xstp) that prevents overlapping reception (loop) of a signal. A transmitter on such a redundant path in the communication networks has a function to discard, when an alternated port is set, a standby signal resulting from redundancy of an active signal in the alternated port.

Patent document 1: Japanese Laid-open Patent Publication No. 2006-49963

In a case where a standby signal to be discarded competes with another service signal for a single port, the transmitter allocates the available band of the port to the standby signal although the standby signal is to be discarded, thereby inhibiting transmission of the service signal. As a result, the physical band is not effectively used.

### SUMMARY

According to an aspect of the embodiments, a transmitter includes an allocating unit, a determining unit and a control unit. The allocating unit allocates, based on priorities of a first signal and a second signal received by a single port in the transmitter, a band of the port to a signal having a higher priority. The determining unit determines whether a local port in the transmitter or a destination of the local port uses the first signal as a standby signal in a redundant configuration. The control unit changes, when the determining unit determines that the local port or the destination uses the first signal as the standby signal, the priority of the second signal received by the local port such that the priority of the second signal is higher than the priority of the first signal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an example diagram for explaining each node in a transmission system according to an embodiment of the present invention;

FIG. 2 is an example diagram for explaining the transmission system according to the present embodiment;

FIG. 3 is an example diagram for explaining a priority table;

FIG. 4 is a state transition diagram of a port in each node;

FIG. 5 is an example diagram for explaining the transmission system in a case where a single port is in a competitive state;

FIGS. 6A and 6B are example diagrams for explaining an allocation structure of the available band of the port to each signal in a case where the single port is in a competitive state;

FIG. 7 is an example diagram for explaining an operation of the transmission system before priority setting is performed (in a case where a port of a destination node is an alternated port);

FIG. 8 is an example diagram for explaining an operation of the transmission system after the priority setting is performed (in a case where the port of the destination node is an alternated port);

FIG. 9 is an example diagram for explaining an operation of the transmission system before the priority setting is performed (in a case where a local port is an alternated port);

FIG. 10 is an example diagram for explaining an operation of the transmission system after the priority setting is performed (in a case where the local port is an alternated port);

FIG. 11 is an example flowchart of a processing operation of a node relating to the priority setting;

FIG. 12 is another example flowchart of the processing operation of the node relating to the priority setting; and

FIG. 13 is an example diagram for explaining a transmitter that executes a transmission program.

### DESCRIPTION OF EMBODIMENTS

Preferred embodiments of the present invention will be explained with reference to accompanying drawings. The embodiments are not intended to limit the disclosed technology. The embodiments below may be optionally combined without causing any inconsistency.

### [a] Embodiment

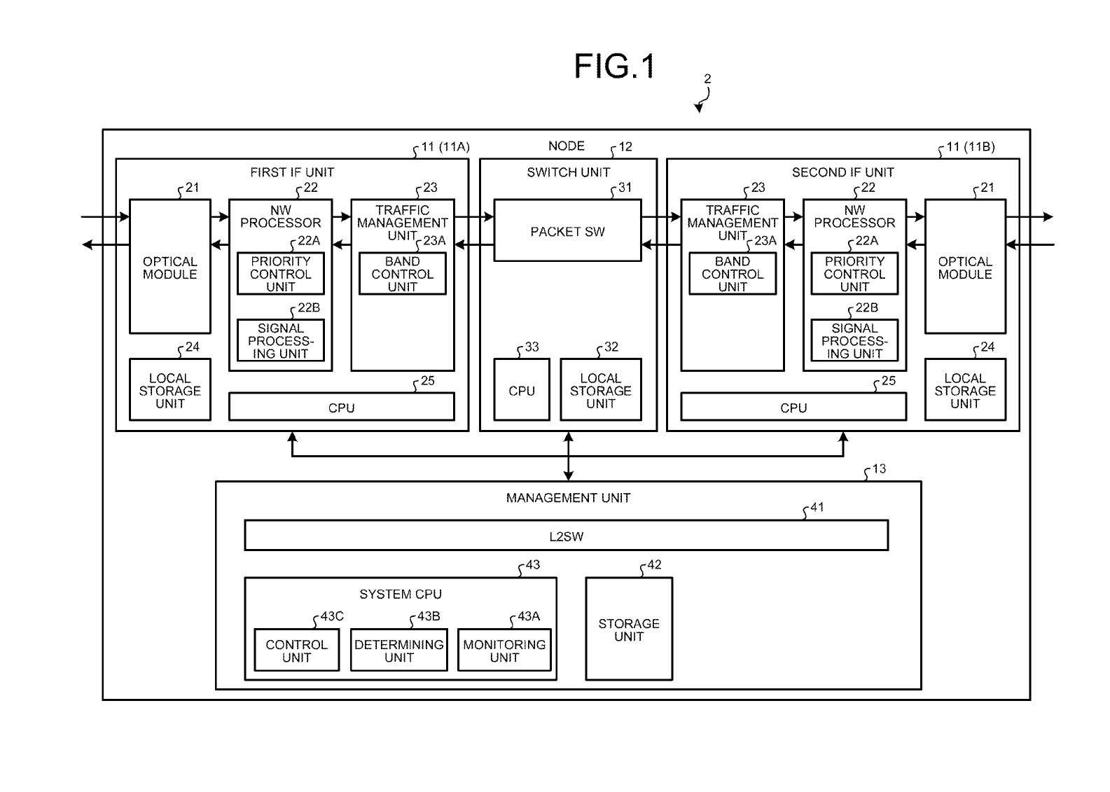

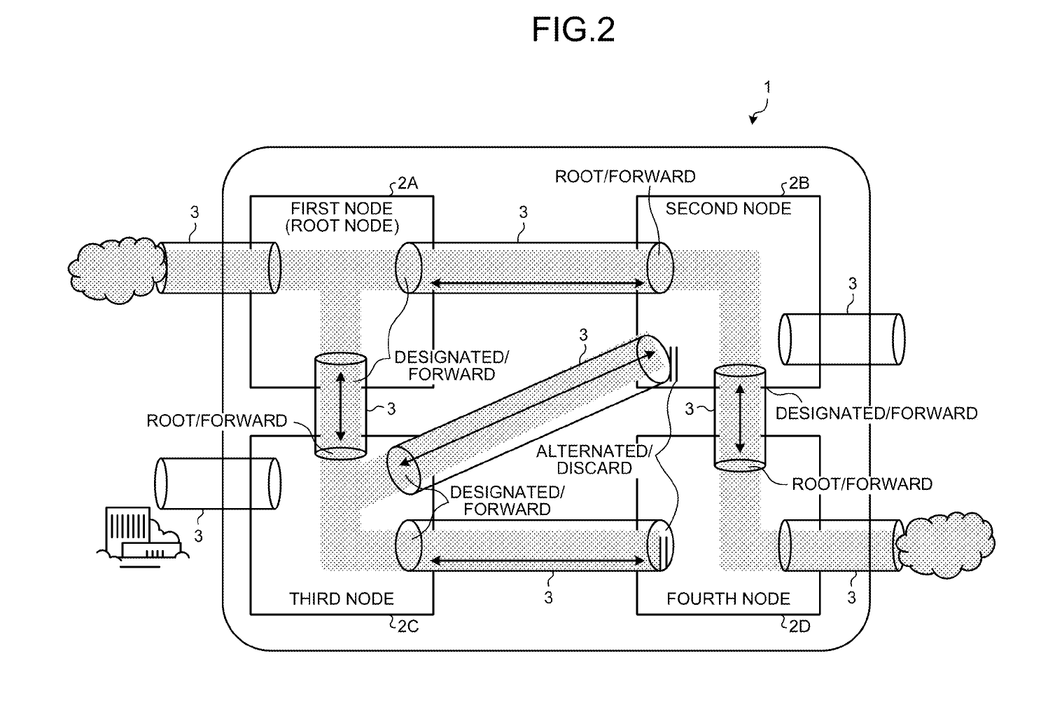

FIG. 1 is an example diagram for explaining each node in a transmission system according to an embodiment of the present invention. FIG. 2 is an example diagram for explaining the transmission system according to the present embodiment. A transmission system 1 illustrated in FIG. 2 includes a plurality of nodes 2 connected via optical lines 3. As illustrated in FIG. 2, the transmission system 1 includes four nodes 2, which are a first node 2A, a second node 2B, a third node 2C, and a fourth node 2D, for the convenience of explanation. The nodes 2 each have a plurality of interface units (hereinafter referred to as IF units) 11, a switch unit (hereinafter referred to as a SW unit) 12, and a management unit 13. The IF unit 11 corresponds to an input-output port connected to the optical line 3. The IF unit 11 includes an optical module 21, a network processor (hereinafter referred to as a NW processor) 22, a traffic management unit 23, a local storage unit 24, and a central processing unit (CPU) 25. The nodes 2 each include the IF units 11. In a case where two IF units 11 are provided, they are referred to as a first IF unit 11A and a second IF unit 11B, for example. In a case where four IF units 11 are provided, they are referred to as a first IF unit 11A, a second IF unit 11B, a third IF unit 11C, and a fourth IF unit 11D, for example. The number of IF units 11 in each node 2 can be optionally changed.

The optical module 21 is a photoelectric converter that converts an optical signal transmitted from the optical line 3 into an electrical signal and converts an electrical signal into an optical signal to output it to the optical line 3. The NW processor 22, for example, performs signal processing on a frame structure of an electrical signal, such as tag conversion of virtual local area network (VLAN) information, and signal processing on an electrical signal, such as polishing and shaping.

The NW processor 22 includes a priority control unit 22A and a signal processing unit 22B serving as an allocating unit. The priority control unit 22A compares, when a plurality of signals compete with one another for the local port, the priorities of the signals. The priority corresponds to the priority of a signal to be preferentially allocated to the available band of the local port. Assuming “A” denotes the highest priority, the priority is lowered in order of A, B, C, D, E, F, G, and H, for example. The signal processing unit 22B performs signal processing on signals received by the local port based on the comparison result of the priorities of the signals received by the local port. In a case where the priority of an mp2mp signal received by the local port is “C” and the priority of a p2p signal received by the local port is “F”, for example, the priority control unit 22A compares the priorities of the signals. Because the priority of the mp2mp signal is higher than that of the p2p signal, the signal processing unit 22B preferentially allocates the available band of the local port to the mp2mp signal and allocates an excess available band of the local port to the p2p signal. As a result, the signal processing unit 22B preferentially outputs the mp2mp signal. In a case where a port-role/port-state of the local port is alternated/discard, for example, the signal processing unit 22B discards the mp2mp signal received by the local port.

The traffic management unit 23 includes a band control unit 23A. The band control unit 23A refers to priority processing information added by the signal processing unit 22B to perform output band control. The CPU 25 collectively controls the IF unit 11. Furthermore, the CPU 25 terminates a bridge protocol data unit (BPDU) signal serving as a control signal transmitted from other nodes 2. The local storage unit 24 is an area that stores therein various types of information, such as local software, used by the IF unit 11.

The SW unit 12 switches signal paths for each signal flow between the IF units 11. The SW unit 12 includes a packet SW 31, a local storage unit 32, and a CPU 33. The packet SW 31 switches signal paths for each signal flow between the IF units 11. The local storage unit 32 is an area that stores therein various types of information, such as local software, used by the SW unit 12. The CPU 33 collectively controls the SW unit 12.

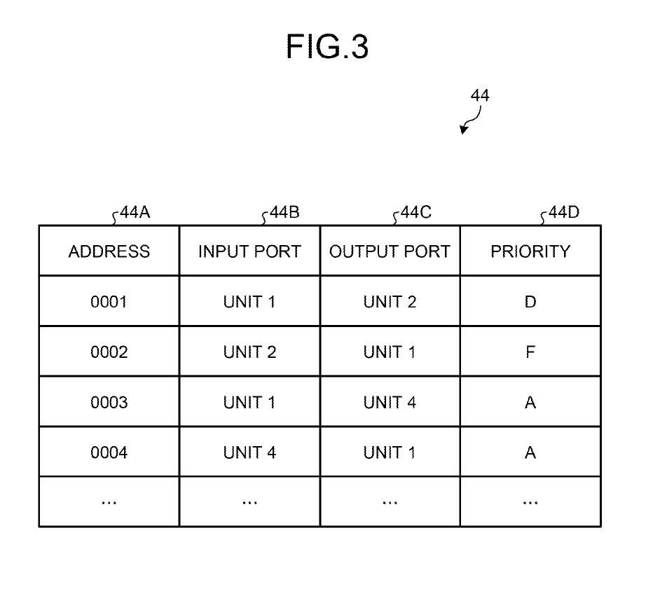

The management unit 13 collectively controls the node 2 and includes an L2SW 41, a storage unit 42, and a system CPU 43. The L2SW 41 is used to communicate with the CPU 25 in each IF unit 11 and the CPU 33 in the SW unit 12. The storage unit 42 is an area that stores therein various types of information, such as system software. The various types of information includes a priority table 44. FIG. 3 is an example diagram for explaining the priority table 44.

The priority table 44 illustrated in FIG. 3 manages a used path for each signal in each service and associates an address 44A, an input port 44B, an output port 44C, and a priority 44D with one another. The address 44A is information for identifying a storage area in the priority table 44. The input port 44B is information for identifying the IF unit 11 serving as an input port of the used path. The output port 44C is information for identifying the IF unit 11 serving as an output port of the used path. The priority 44D is the priority of a signal passing through the used path.

The system CPU 43 includes a monitoring unit 43A, a determining unit 43B, and a control unit 43C. The monitoring unit 43A uses a BPDU signal in each node 2 acquired via the NW processor 22 in each IF unit 11, thereby acquiring state information such as a port role and a port state of a port corresponding to the IF unit 11 in each node 2.

The determining unit 43B checks the port-role/port-state of the local port or a destination of the local port based on the result of acquisition of the state information. The determining unit 43B then determines whether the local port or the destination discards an mp2mp signal as a standby signal. When the local port is alternated/discard, the determining unit 43B determines that the local port discards the mp2mp signal as the standby signal. By contrast, when an input port in a destination node 2 serving as the destination of the local port is alternated/discard, the determining unit 43B determines that the destination discards the mp2mp signal as a standby signal. When the control unit 43C determines that the local port or the destination discards the mp2mp signal as a standby signal, the control unit 43C searches for a used path for the mp2mp signal and a p2p signal from a table, which is not illustrated. The control unit 43C acquires the priorities of the mp2mp signal and the p2p signal in the searched used path from the priority table 44. The control unit 43C compares the priority of the p2p signal with that of the mp2mp signal and changes the priority of the p2p signal received by the local port such that the priority of the p2p signal is higher than that of the mp2mp signal.

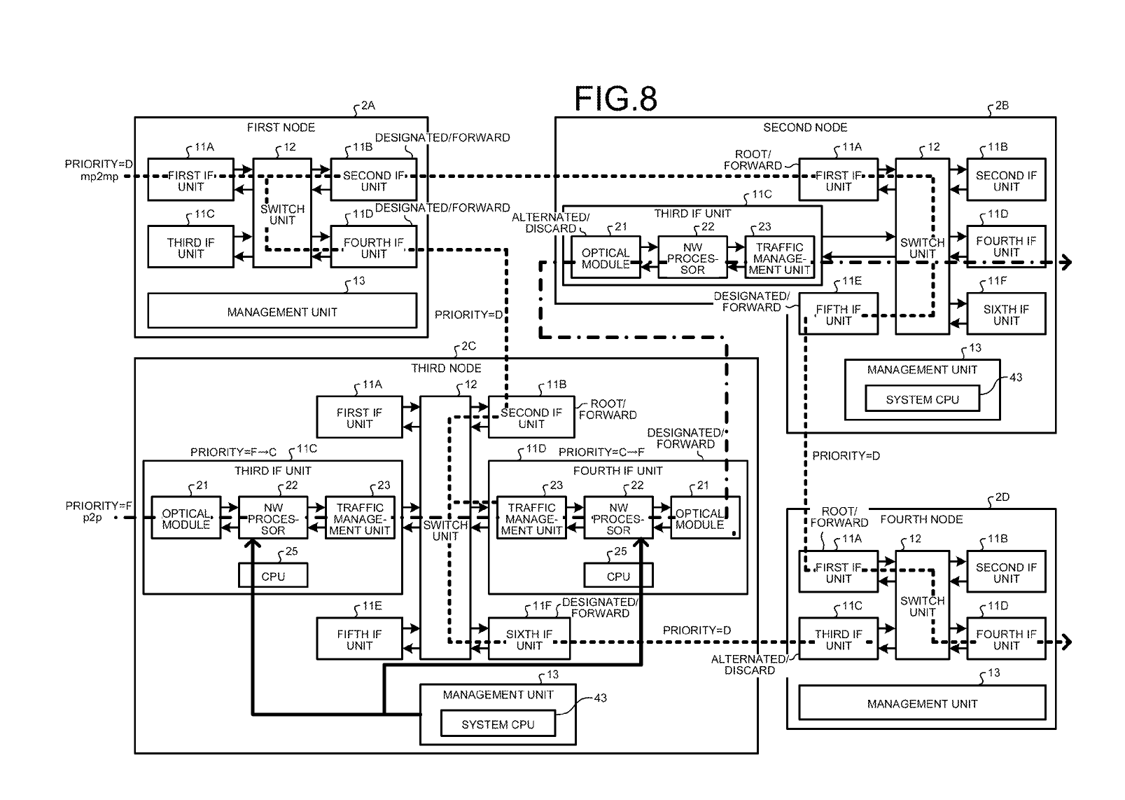

When the control unit 43C determines that the destination discards the mp2mp signal as a standby signal and when the priority of the p2p signal is “F” and the priority of the mp2mp signal is “D”, for example, the control unit 43C changes the priority of the p2p signal from “F” to “C”. The control unit 43C then outputs a change request to change the priority of the p2p signal from “F” to “C” to the priority control unit 22A of the IF unit 11 serving as an input port positioned at the previous stage of the local port that receives the p2p signal and the standby signal of the mp2mp signal. As illustrated in FIG. 8, in a case where the local port is the fourth IF unit 11D in the third node 2C, for example, the input port positioned at the previous stage of the local port is the third IF unit 11C in the third node 2C for the convenience of explanation. The control unit 43C outputs a restoration request to restore the priority of the p2p signal from “C” to the state before the change, that is, to “F” after the allocation of the available band to the priority control unit 22A of the IF unit 11 serving as the local port that receives the p2p signal and the standby signal of the mp2mp signal. When the priority control unit 22A in the IF unit 11 positioned at the previous stage of the local port detects the change request, the priority control unit 22A changes the priority of the p2p signal from “F” to “C”. The signal processing unit 22B in the IF unit 11 positioned at the previous stage of the local port changes the priority of the p2p signal and inputs the p2p signal of “C” to the IF unit 11 serving as the local port via the SW unit 12.

The signal processing unit 22B in the IF unit 11 of the local port receives the standby signal of the mp2mp signal and the p2p signal. Because the priority of the p2p signal is higher than that of the mp2mp signal, the signal processing unit 22B preferentially allocates the available band of the local port to the p2p signal. After preferentially allocating the available band of the local port to the p2p signal, the signal processing unit 22B in the IF unit 11 of the local port preferentially outputs the p2p signal. Because the restoration request has been detected, the signal processing unit 22B performs the following processing to preferentially output the p2p signal: the signal processing unit 22B restores the priority of the p2p signal to be output from “C” to the state before the change, that is, to “F” and outputs the p2p signal with the priority of “F” to an opposite node 2. In other words, after preferentially allocating the available band of the local port to the p2p signal, the signal processing unit 22B restores the priority of the p2p signal to the priority before the change. This mechanism can prevent the influence of the change in the priority on the opposite node 2 serving as the destination.

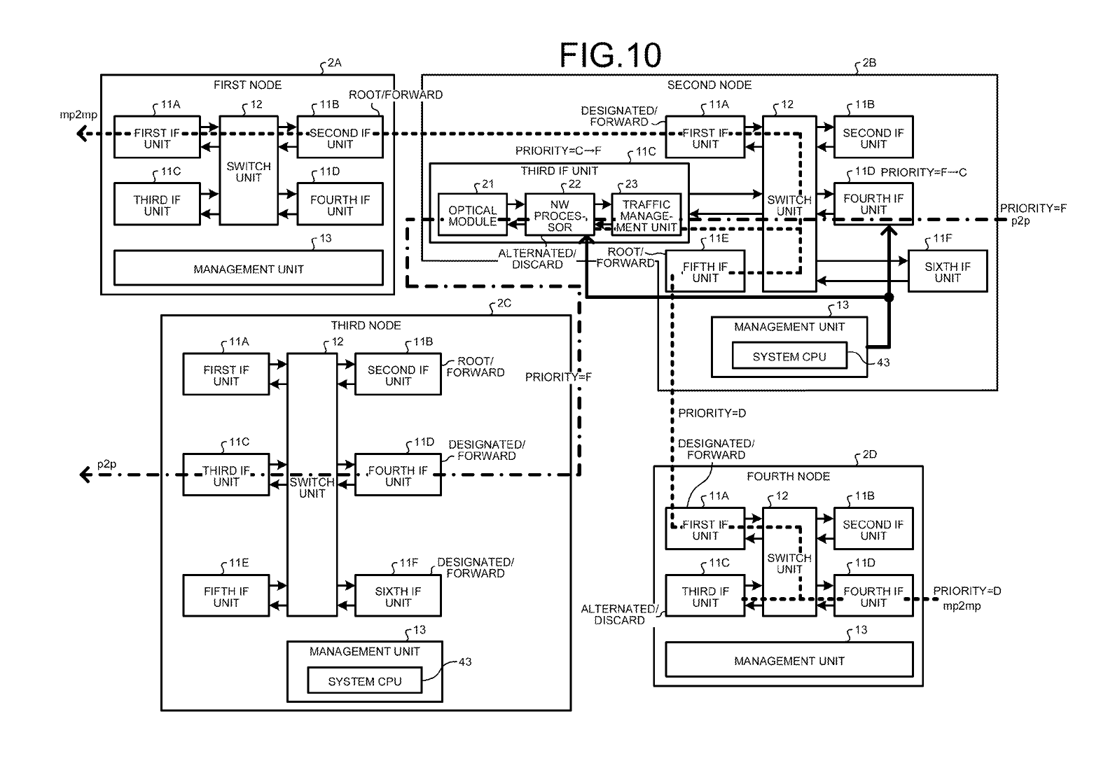

The control unit 43C determines that the destination corresponds to an output port for the local port in the local node 2 and that the destination discards the mp2mp signal as a standby signal. When the control unit 43C determines that the destination discards the mp2mp signal as a standby signal and when the priority of the p2p signal is “F” and the priority of the mp2mp signal is “D”, for example, the control unit 43C changes the priority of the p2p signal from “F” to “C”. The control unit 43C then outputs a change request to change the priority of the p2p signal from “F” to “C” to the priority control unit 22A in the IF unit 11 of the local port that receives the p2p signal and the standby signal of the mp2mp signal. As illustrated in FIG. 10, in a case where the local port is the fourth IF unit 11D in the second node 2B, for example, the output port for the local port corresponds to the third IF unit 11C in the second node 2B for the convenience of explanation. The control unit 43C outputs a restoration request to restore the priority of the p2p signal from “C” to the state before the change, that is, to “F” to the priority control unit 22A in the IF unit 11 of the local port that receives the p2p signal and the standby signal.

When the priority control unit 22A in the IF unit 11 of the local port detects the change request, the priority control unit 22A changes the priority of the p2p signal from “F” to “C”. The signal processing unit 22B in the IF unit 11 of the local port changes the priority of the p2p signal and inputs the p2p signal of “C” to the IF unit 11 of the output port via the SW unit 12.

The signal processing unit 22B in the IF unit 11 of the output port receives the standby signal of the mp2mp signal and the p2p signal. Because the priority of the p2p signal is higher than that of the mp2mp signal, the signal processing unit 22B preferentially allocates the available band of the output port to the p2p signal. After preferentially allocating the available band to the p2p signal, the signal processing unit 22B in the IF unit 11 of the output port preferentially outputs the p2p signal. Because the restoration request has been detected, the signal processing unit 22B performs the following processing to preferentially output the p2p signal: after preferentially allocating the available band to the p2p signal, the signal processing unit 22B restores the priority of the p2p signal to be output from “C” to the state before the change, that is, to “F” and outputs the p2p signal with the priority of “F” to a destination node 2. In other words, after preferentially allocating the available band of the local port to the p2p signal, the signal processing unit 22B restores the priority of the p2p signal to the priority before the change. This mechanism can prevent the influence of the change in the priority on the destination node 2.

In the transmission system 1 illustrated in FIG. 2, the first node 2A serves as a root node and distributes an mp2mp signal to the fourth node 2D, for example. The active path to distribute the mp2mp signal extends in order of the first node 2A, the second node 2B, and the fourth node 2D. In this case, the port-role/port-state of the first node 2A on the active path from the first node 2A to the second node 2B is designated/forward, and the port-role/port-state of the second node 2B on the path is root/forward. The port-role/port-state of the second node 2B on the active path from the second node 2B to the fourth node 2D is designated/forward, and the port-role/port-state of the fourth node 2D on the path is root/forward.

Alternated paths to distribute the mp2mp signal includes a first alternated path and a second alternated path. The first alternated path extends in order of the first node 2A, the third node 2C, and the fourth node 2D, whereas the second alternated path extends in order of the first node 2A, the third node 2C, the second node 2B, and the fourth node 2D. The port-role/port-state of the first node 2A on the first alternated path from the first node 2A to the third node 2C is designated/forward, and the port-role/port-state of the third node 2C on the path is root/forward. The port-role/port-state of the third node 2C on the first alternated path from the third node 2C to the fourth node 2D is designated/forward, and the port-role/port-state of the fourth node 2D on the path is alternated/discard. To avoid overlapping reception of the mp2mp signal from the first node 2A on the active path, the fourth node 2D is set to alternated/discard, thereby discarding the standby signal from the third node 2C.

The port-role/port-state of the first node 2A on the second alternated path from the first node 2A to the third node 2C is designated/forward, and the port-role/port-state of the third node 2C on the path is root/forward. The port-role/port-state of the third node 2C on the second alternated path from the third node 2C to the second node 2B is designated/forward, and the port-role/port-state of the second node 2B on the path is alternated/discard. To avoid overlapping reception of the mp2mp signal from the first node 2A on the active path, the second node 2B is set to alternated/discard, thereby discarding the standby signal from the third node 2C.

In other words, the transmission system 1 illustrated in FIG. 2 uses the active path to distribute the mp2mp signal from the first node 2A to the fourth node 2D. When a failure occurs in the active path, the transmission system 1 switches the active path to the first alternated path or the second alternated path. The first node 2A distributes the mp2mp signal to the fourth node 2D via the first alternated path available after the switching, for example. Because the fourth node 2D on the first alternated path is set to alternated/discard, the fourth node 2D discards the standby signal of the mp2mp signal transmitted from the third node 2C. Because the second node 2B on the second alternated path is set to alternated/discard, the second node 2B discards the standby signal of the mp2mp signal transmitted from the third node 2C.

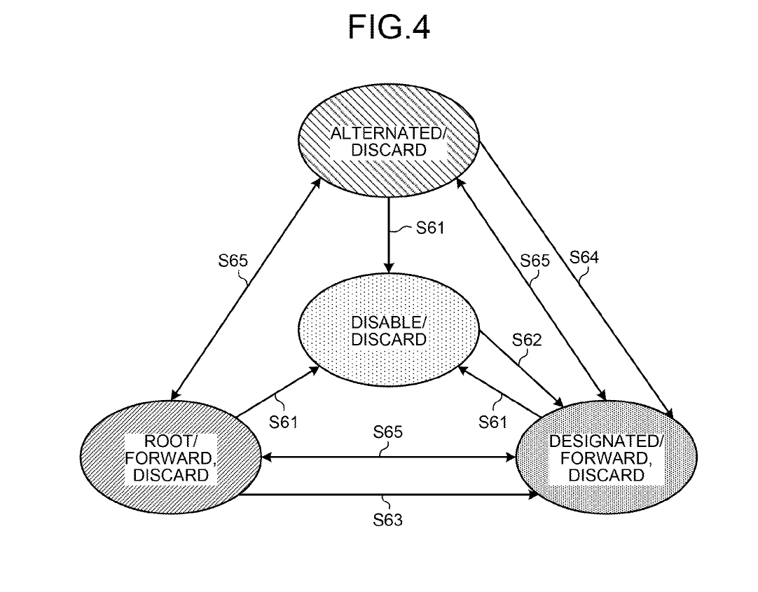

FIG. 4 is a state transition diagram of the port in each node 2. The IF unit 11 corresponding to the port in each node 2 has four types of port roles, which are designated, root, alternated, and disable. Designated corresponds to a port used in the active path or the alternated path. Root corresponds to a port used for a signal transmitted from a root node. Alternated corresponds to a port that discards a received standby signal in the alternated path. Disable corresponds to a closed port. The IF unit 11 has two types of port state, which are forward and discard, for example. Forward is a port state to transfer a signal, whereas discard is a port state to discard a signal.

When a failure on the path is detected, the designated, root, and alternated ports transit to the disable/discard port (Step S61). When recovery of the failure on the path is detected, the disable/discard port transits to the designated/forward (discard) port (Step S62). When termination of the BPDU signal from the destination node 2 is detected, the root/forward (discard) port transits to the designated/forward (discard) port (Step S63). When termination of the BPDU signal from the destination node 2 is detected, the alternated/forward (discard) port transits to the designated/forward (discard) port (Step S64). The designated/forward (discard) port transits to the alternated or root/forward (discard) port in response to a proposal of the BPDU signal from the destination node 2 (Step S65). The alternated/forward (discard) port transits to the designated or root/forward (discard) port in response to a proposal of the BPDU signal (Step S65). The root/forward (discard) port transits to the designated or alternated/forward (discard) port in response to a proposal of the BPDU signal (Step S65).

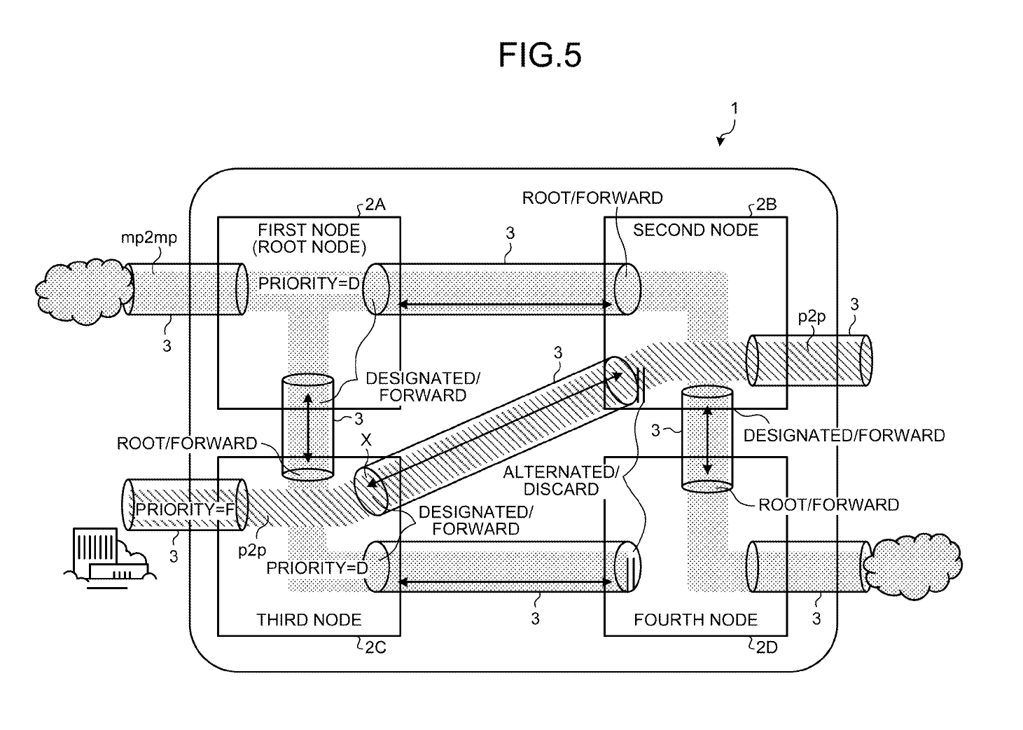

FIG. 5 is an example diagram for explaining the transmission system 1 in a case where a single port is in a competitive state. The p2p signal illustrated in FIG. 5 is distributed via the path from the third node 2C to the second node 2B, for example. The active path for the mp2mp signal, the first alternated path, and the second alternated path are the same as those in the transmission system 1 illustrated in FIG. 2 for the convenience of explanation. The priority of the mp2mp signal is “D”, and that of the p2p signal is “F”.

When a plurality of signals compete with one another for the local port, the IF unit 11 in each node 2 acquires and compares the priorities of the signals. Based on the result of comparison of the priorities, the IF unit 11 performs shaping of preferentially allocating the available band of the local port to a signal having a higher priority.

In the transmission system 1 in FIG. 5, a port X of the third node 2C used to distribute the p2p signal is also used for the second alternated path for the mp2mp signal. Thus, the port X is in a competitive state for distribution of the p2p signal and the mp2mp signal. Even when the p2p signal competes with the mp2mp signal for the port X in the third node 2C, and the priority of the mp2mp signal is higher than that of the p2p signal, the mp2mp signal is an object to be discarded in the second node 2B on the second alternated path. Therefore, the third node 2C changes the priority of the p2p signal such that the priority of the p2p signal is higher than that of the mp2mp signal. As a result, the third node 2C preferentially allocates the available band of the port X to the p2p signal, thereby preferentially outputting the p2p signal on the path from the third node 2C to the second node 2B.

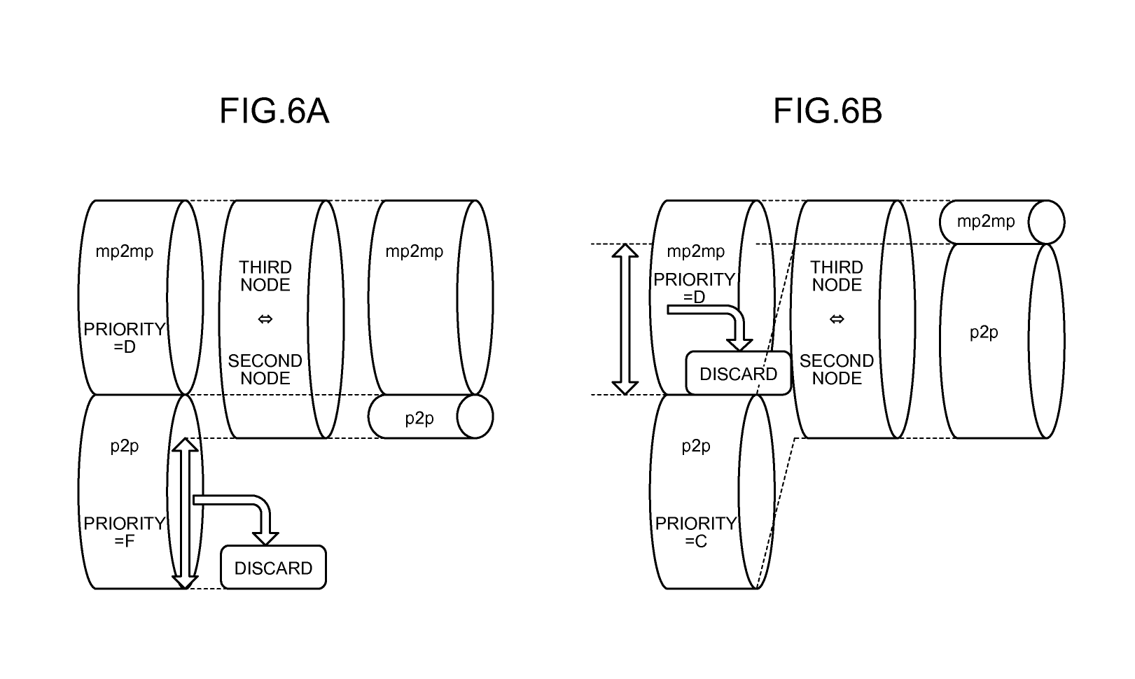

FIGS. 6A and 6B are example diagrams for explaining an allocation structure of the available band of the port to each signal in a case where the single port is in a competitive state. In the port X of the third node 2C illustrated in FIG. 6A, the priority of the mp2mp signal is “D”, and that of the p2p signal is “F”. The third node 2C preferentially allocates the available band to the mp2mp signal and allocates the excess available band to the p2p signal. Because the mp2mp signal is a standby signal to be discarded in the second node 2B on the second alternated path, the port X of the third node 2C changes the priority of the p2p signal from “F” to “C”. As a result, the priority “C” of the p2p signal is higher than that of the mp2mp signal in the port X of the third node 2C illustrated in FIG. 6B. The third node 2C preferentially allocates the available band to the p2p signal and allocates the excess available band to the mp2mp signal. Thus, the p2p signal can be transmitted without being inhibited by the mp2mp signal to be discarded.

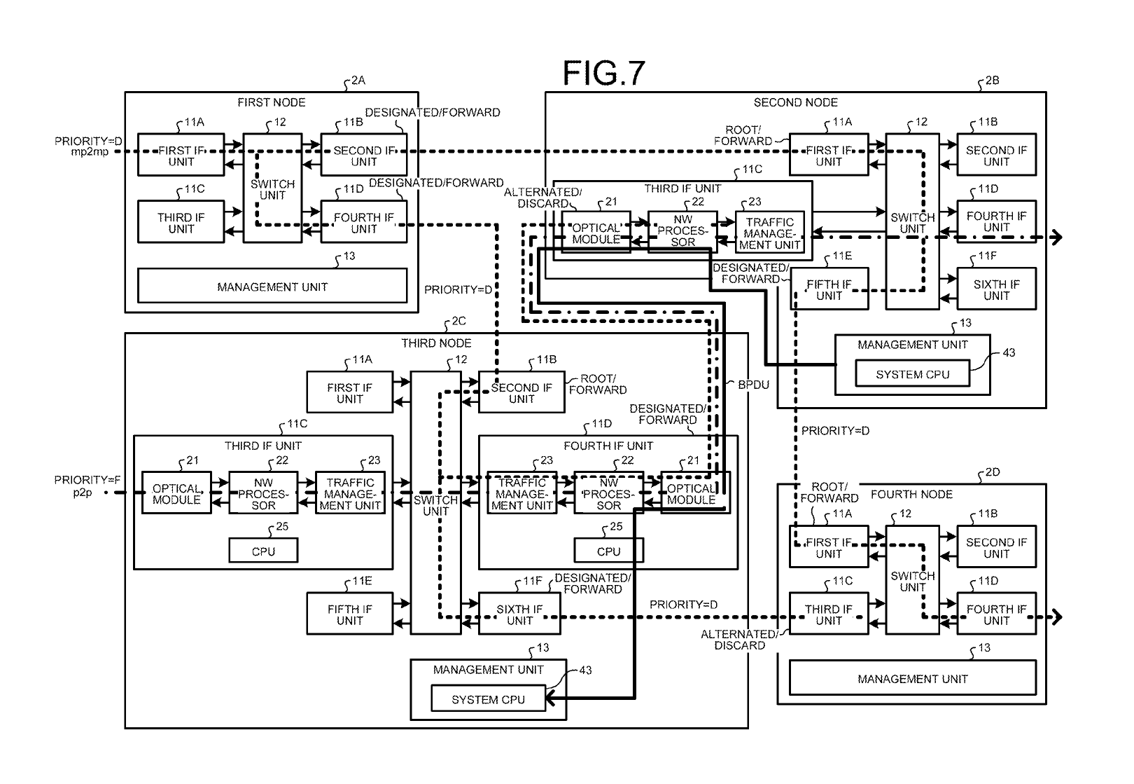

The following describes an operation of the transmission system 1 according to the present embodiment. FIG. 7 is an example diagram for explaining an operation of the transmission system 1 before the priority setting is performed (in a case where a port of the destination node 2 is an alternated port). FIG. 8 is an example diagram for explaining an operation of the transmission system 1 after the priority setting is performed (in a case where the port of the destination node 2 is an alternated port). The transmission system 1 illustrated in FIGS. 7 and 8 uses the path from the third node 2C to the second node 2B for the p2p signal and uses the active path, the first alternated path, and the second alternated path illustrated in FIG. 2 for the mp2mp signal for the convenience of explanation. The priority of the mp2mp signal is “D”, and that of the p2p signal is “F”. The p2p signal competes with the standby signal of the mp2mp signal for the fourth IF unit 11D of the third node 2C.

The monitoring unit 43A in the system CPU 43 in the management unit 13 of the second node 2B performs BPDU communications with the system CPU 43 in the management unit 13 of the third node 2C, thereby acquiring state information. The determining unit 43B in the system CPU 43 of the third node 2C determines that the port-role/port-state of the third IF unit 11C in the second node 2B is alternated/discard.

When the opposite port is alternated/discard, the determining unit 43B of the third node 2C determines that the opposite port discards the mp2mp signal as a standby signal. When it is determined that the opposite port discards the mp2mp signal as a standby signal, the control unit 43C of the third node 2C outputs a change request to change the priority of the p2p signal from “F” to “C” such that the priority of the p2p signal is higher than that of the mp2mp signal to the priority control unit 22A of the third IF unit 11C serving as the input stage of the local port.

When the change request is detected, the NW processor 22 in the third IF unit 11C in the third node 2C illustrated in FIG. 8 changes the priority of the received p2p signal from “F” to “C”. The fourth IF unit 11D in the third node 2C compares the priorities of the p2p signal received from the third IF unit 11C and the mp2mp signal received from the second IF unit 11B. The fourth IF unit 11D compares the priority “C” of the p2p signal with the priority “D” of the mp2mp signal, thereby preferentially allocating the available band of the local port to the p2p signal. After preferentially allocating the available band of the local port to the p2p signal, the fourth IF unit 11D restores the priority of the p2p signal to the priority before the change and outputs the p2p signal to the third IF unit 11C of the second node 2B serving as the opposite port. This mechanism can prevent transmission of the p2p signal from being inhibited by the mp2mp signal even when the p2p signal competes with the standby signal of the mp2mp signal for the local port.

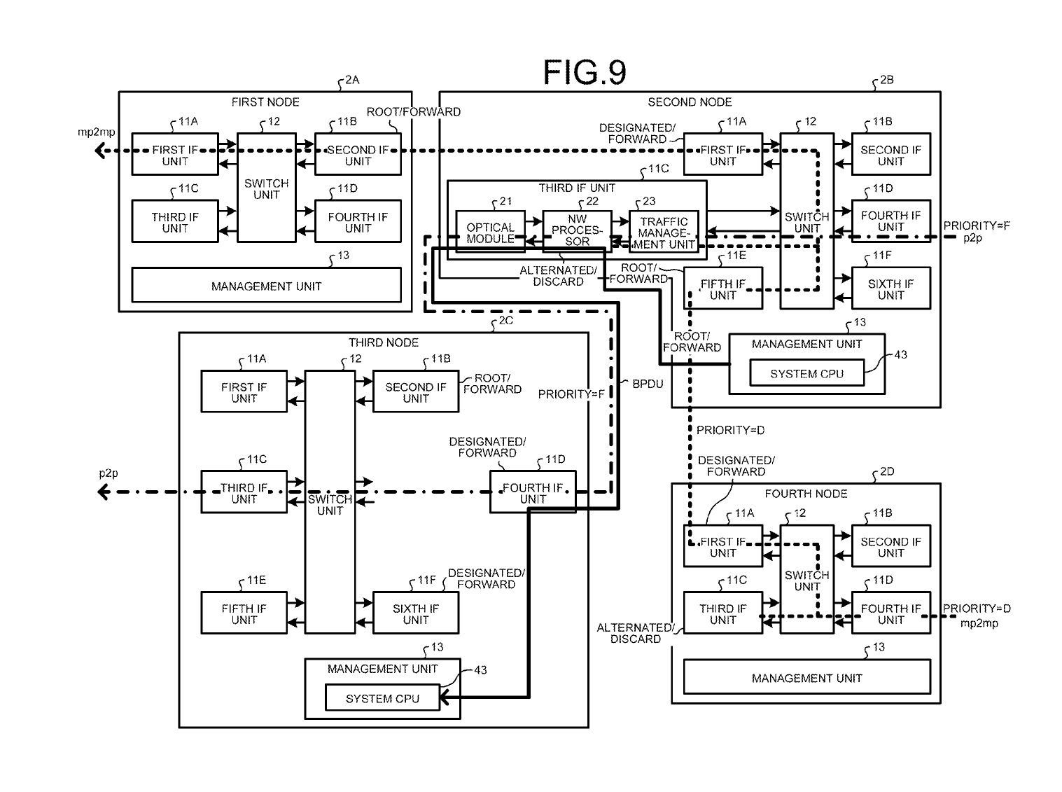

FIG. 9 is an example diagram for explaining an operation of the transmission system 1 before the priority setting is performed (in a case where the local port is an alternated port). FIG. 10 is an example diagram for explaining an operation of the transmission system 1 after the priority setting is performed (in the case where the local port is an alternated port). The transmission system 1 illustrated in FIGS. 9 and 10 uses the path from the second node 2B to the third node 2C for the p2p signal and uses the path extending in order of the fourth node 2D, the second node 2B, and the first node 2A as the active path for the mp2mp signal for the convenience of explanation. The transmission system 1 also uses the path extending in order of the fourth node 2D, the third node 2C, and the first node 2A as the first alternated path and the path extending in order of the fourth node 2D, the second node 2B, the third node 2C, and the first node 2A as the second alternated path. The priority of the mp2mp signal is “D”, and that of the p2p signal is “F”. The p2p signal competes with the standby signal of the mp2mp signal for the third IF unit 11C of the second node 2B.

The monitoring unit 43A in the system CPU 43 in the management unit 13 of the second node 2B monitors the state of the IF units 11 in the local node. The determining unit 43B in the system CPU 43 of the second node 2B checks the port-role/port-state of the third IF unit 11C serving as the local node and determines that it is alternated/discard.

When the local port is alternated/discard, the determining unit 43B of the second node 2B determines that the output port discards the mp2mp signal as a standby signal. When it is determined that the local port discards the mp2mp signal as a standby signal, the control unit 43C of the second node 2B outputs a change request to change the priority of the p2p signal from “F” to “C” such that the priority of the p2p signal is higher than that of the mp2mp signal to the priority control unit 22A of the fourth IF unit 11D serving as the input stage of the local port.

When the change request is detected, the NW processor 22 in the fourth IF unit 11D in the second node 2B illustrated in FIG. 10 changes the priority of the received p2p signal from “F” to “C”. The third IF unit 11C in the second node 2B compares the priorities of the p2p signal received from the fourth IF unit 11D and the mp2mp signal received from a fifth IF unit 11E. The third IF unit 11C compares the priority “C” of the p2p signal with the priority “D” of the mp2mp signal, thereby preferentially allocating the available band of the local port to the p2p signal. After preferentially allocating the available band of the local port to the p2p signal, the third IF unit 11C restores the priority of the p2p signal to the priority before the change and outputs the p2p signal to the fourth IF unit 11D of the third node 2C. This mechanism can prevent transmission of the p2p signal from being inhibited by the mp2mp signal even when the p2p signal competes with the standby signal of the mp2mp signal for the local port.

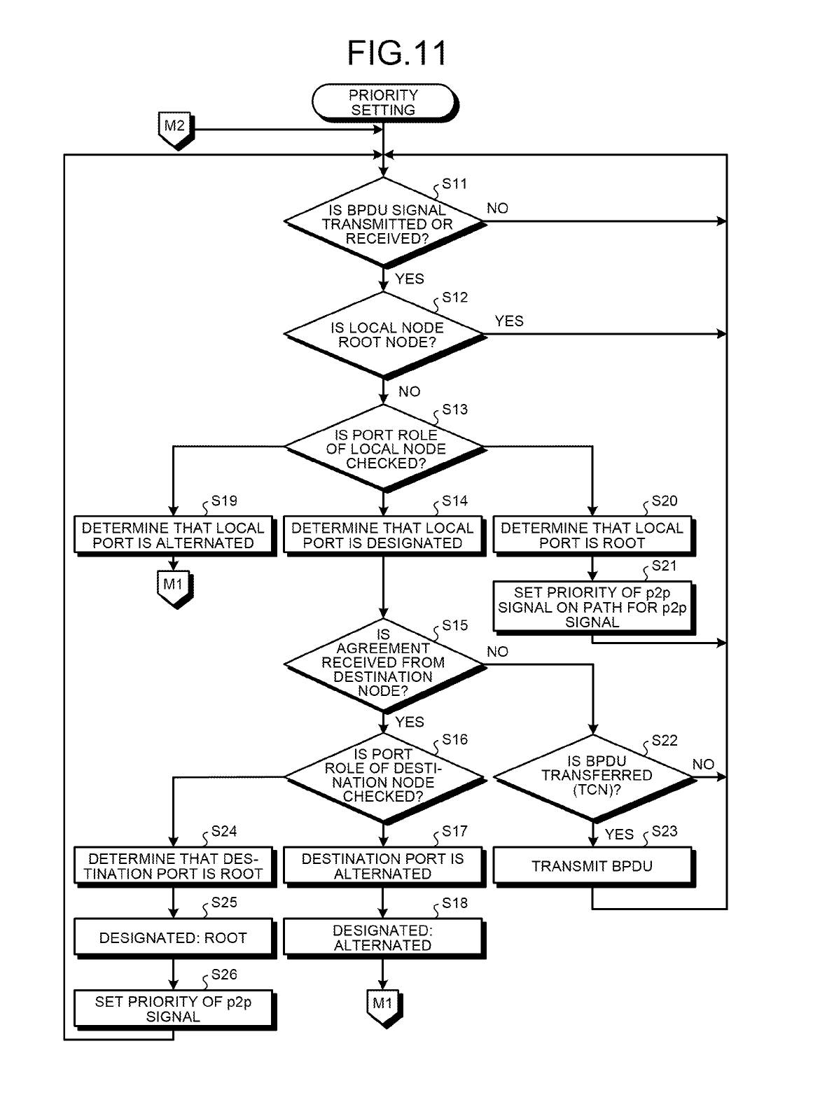

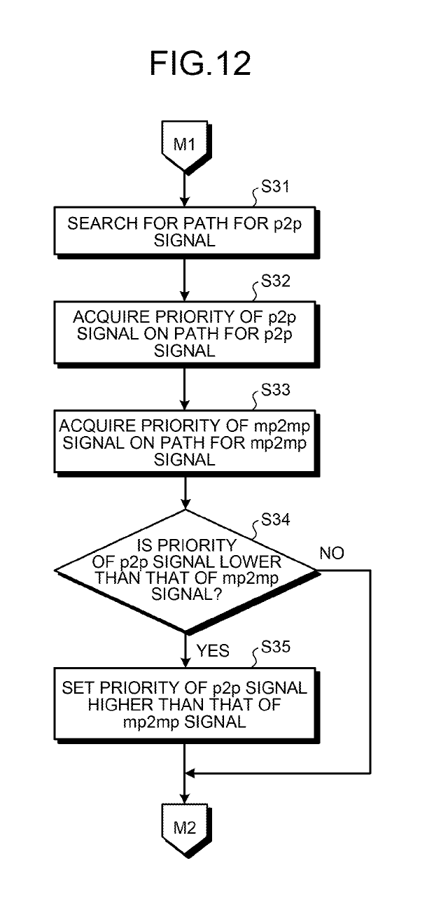

FIGS. 11 and 12 are example flowcharts of a processing operation of the node 2 relating to the priority setting. The priority setting is processing of setting the priority of the p2p signal higher than that of the mp2mp signal in a case where the p2p signal competes with the mp2mp signal for a single port and where the local port or the destination of the local port discards the mp2mp signal as a standby signal.

In FIG. 11, the monitoring unit 43A in the system CPU 43 of the node 2 determines whether a BPDU signal is transmitted to or received from another node 2 (Step S11). When a BPDU signal is transmitted or received (Yes at Step S11), the monitoring unit 43A determines whether the local node 2 is a root node (Step S12).

When the local node 2 is not a root node (No at Step S12), the monitoring unit 43A checks the port role of the local node 2 (Step S13). When it is determined that the local port is designated as the result of checking the port role of the local node 2 (Step S14), the determining unit 43B determines whether agreement is received from the destination node 2 (Step S15). When agreement is received from the destination node 2 (Yes at Step S15), the monitoring unit 43A checks the port role of the destination node 2 (Step S16).

When it is determined that the destination port is alternated as the result of checking the port role of the destination node 2 (Step S17), the determining unit 43B determines the local port role and the destination port role are designated and alternated, respectively (Step S18). The determining unit 43B then determines that the port roles are designated and alternated, and the process proceeds to M1 in FIG. 12.

At M1 in FIG. 12, the control unit 43C in the system CPU 43 searches for the path for the p2p signal (Step S31). The control unit 43C acquires the priority of the p2p signal passing through the searched path for the p2p signal from the priority table 44 (Step S32). The control unit 43C also acquires the priority of the mp2mp signal passing through the path for the mp2mp signal from the priority table 44 (Step S33).

The control unit 43C determines whether the priority of the p2p signal is lower than that of the mp2mp signal (Step S34). When the priority of the p2p signal is lower than that of the mp2mp signal (Yes at Step S34), the control unit 43C sets the priority of the p2p signal higher than that of the mp2mp signal (Step S35), and the process proceeds to M2 in FIG. 11. Because the priority of the p2p signal is set higher than that of the mp2mp signal, the IF unit 11 preferentially allocates the available band to the p2p signal in a case where the p2p signal competes with the standby signal of the mp2mp signal. When there is an excess available band, the IF unit 11 allocates the excess available band to the mp2mp signal.

When the priority of the p2p signal is not lower than that of the mp2mp signal (No at Step S34), the process performed by the control unit 43C proceeds to M2 in FIG. 11 without changing the priority. The IF unit 11 compares the priorities of the p2p signal and the standby signal of the mp2mp signal, thereby preferentially allocating the available band to the signal having a higher priority.

When it is determined that the local port is alternated as the result of checking the port role of the local node 2 at Step S13 (Step S19), the process performed by the determining unit 43B proceeds to M1 in FIG. 11. When no BPDU signal is transmitted or received (No at Step S11) or the local node is a root node (Yes at Step S12), the process performed by the monitoring unit 43A is returned to Step S11 in FIG. 11.

When it is determined that the local port is root as the result of checking the port role of the local node 2 performed by the monitoring unit 43A at Step S13 (Step S20), the control unit 43C sets the priority of the p2p signal on the path for the p2p signal (Step S21). The process is then returned to Step S11 without changing the priority.

When no agreement is received from the destination node 2 (No at Step S15), the monitoring unit 43A determines whether a BPDU signal of TCN is transferred (Step S22). When the BPDU signal of TCN is transmitted (Yes at Step S22), the monitoring unit 43A transmits the BPDU signal (Step S23), and the process is then returned to Step S11 without changing the priority. When no BPDU signal of TCN is transferred (No at Step S22), the process performed by the monitoring unit 43A is returned to Step S11 without changing the priority.

When it is determined that the destination port is root as the result of checking the port role of the destination node 2 performed by the monitoring unit 43A at Step S16 (Step S24), it is determined that the port role of the local node 2 and the port role of the destination node 2 are designated and root, respectively (Step S25). The control unit 43C sets the priority of the p2p signal (Step S26), and the process is returned to Step S11 without changing the priority.

In a case where the p2p signal competes with the mp2mp signal for a single port and where the port of the destination node 2 discards the standby signal of the mp2mp signal, the node 2 performing the priority setting sets the priority of the p2p signal higher than that of the mp2mp signal. The node 2 then preferentially allocates the available band of the port to the p2p signal, thereby preferentially outputting the p2p signal. This mechanism can prevent transmission of the p2p signal from being inhibited by the standby signal of the mp2mp signal to be discarded. Thus, it is possible to effectively use the physical band.

In a case where the p2p signal competes with the mp2mp signal for a single port and where the local port discards the standby signal of the mp2mp signal, the node 2 sets the priority of the p2p signal higher than that of the mp2mp signal. The node 2 then preferentially allocates the available band of the port to the p2p signal, thereby preferentially outputting the p2p signal. This mechanism can prevent transmission of the p2p signal from being inhibited by the standby signal of the mp2mp signal to be discarded. Thus, it is possible to effectively use the physical band.

In a case where the mp2mp signal competes with the p2p signal for the local port and where the local port discards the mp2mp signal as a standby signal in a redundant configuration, the node 2 according to the embodiment above changes the priority of the p2p signal received by the local port such that the priority of the p2p signal is higher than that of the mp2mp signal. Making the priority of the p2p signal higher can prevent transmission of the p2p signal from being inhibited by the mp2mp signal to be discarded. Thus, it is possible to effectively use the physical band.

In a case where the mp2mp signal competes with the p2p signal for the local port and where the destination of the local port discards the mp2mp signal as a standby signal, the node 2 changes the priority of the p2p signal received by the local port such that the priority of the p2p signal is higher than that of the mp2mp signal. Making the priority of the p2p signal higher can prevent transmission of the p2p signal from being inhibited by the mp2mp signal to be discarded. Thus, it is possible to effectively use the physical band.

The node 2 changes the priority of the p2p signal in the IF unit 11 positioned at the previous stage before the local port receives the mp2mp signal and the p2p signal, thereby preferentially allocating the available band of the local port to the p2p signal. Because the node 2 changes the priority of the p2p signal in the IF unit 11 positioned at the previous stage before the local port for which the p2p signal competes with the mp2mp signal receives the signals, it is possible to minimize the influence of the change in the priority.

After changing the priority of the p2p signal and allocating the available band of the local port to the mp2mp signal and the p2p signal, the node 2 restores the priority of the p2p signal to the priority before the change and outputs the p2p signal. This mechanism can prevent the influence of the change in the priority on the destination node 2.

The node 2 acquires the state information indicating the state of the destination node 2 or the port of the destination node with the BPDU signal. When the state information of the destination port indicates alternated/discard, the node 2 determines that the destination port discards the mp2mp signal as a standby signal. Thus, the node 2 can easily check the port state of the destination node 2 with the BPDU signal.

The embodiment above has described a case where the mp2mp signal competes with the p2p signal for a single port. Alternatively, the embodiment may change the priority of the p2p signal in a case where the mp2mp signal is a standby signal regardless of whether to discard the mp2mp signal in the single port.

While the embodiment above has described a case where the mp2mp signal is a signal in a redundant configuration in a multicast system, the present invention is also applicable to a signal in a broadcast system having a redundant configuration.

The embodiment above changes the priority of the p2p signal in a case where the p2p signal competes with the mp2mp signal for the local port and where the local port or the destination of the local port discards the mp2mp signal as a standby signal. The p2p signal is not limited to a signal in a unicast system, and the present invention is also applicable to a signal in a multicast system or a broadcast system. In a case where a first signal (active signal) in a multicast system competes with a second signal (standby signal) for the local port and where the local port discards the second signal, for example, the embodiment may change the priority of the first signal serving as the active signal.

The embodiment above changes the priority of the p2p signal such that the priority of the p2p signal is higher than that of the mp2mp signal. Alternatively, the embodiment may change the priority of the mp2mp signal such that the priority of the p2p signal is higher than that of the mp2mp signal. Because the mp2mp signal is a signal in a multicast system, the change in the priority affects other nodes 2. Therefore, the embodiment preferably changes the priority of the p2p signal.

The components of each unit illustrated in the drawings are not necessarily physically configured as illustrated. In other words, the specific aspects of distribution and integration of each unit are not limited to those illustrated in the drawings. All or a part of the components may be distributed or integrated functionally or physically in desired units depending on various types of loads and usage, for example.

All or a desired part of various types of processing functions performed by each device may be carries out by a CPU (or a microcomputer, such as a micro processing unit (MPU) and a micro controller unit (MCU)). Needless to say, all or a desired part of various types of processing functions may be carried out on a computer program analyzed and executed by the CPU (or the microcomputer, such as an MPU and an MCU) or on hardware by wired logic.

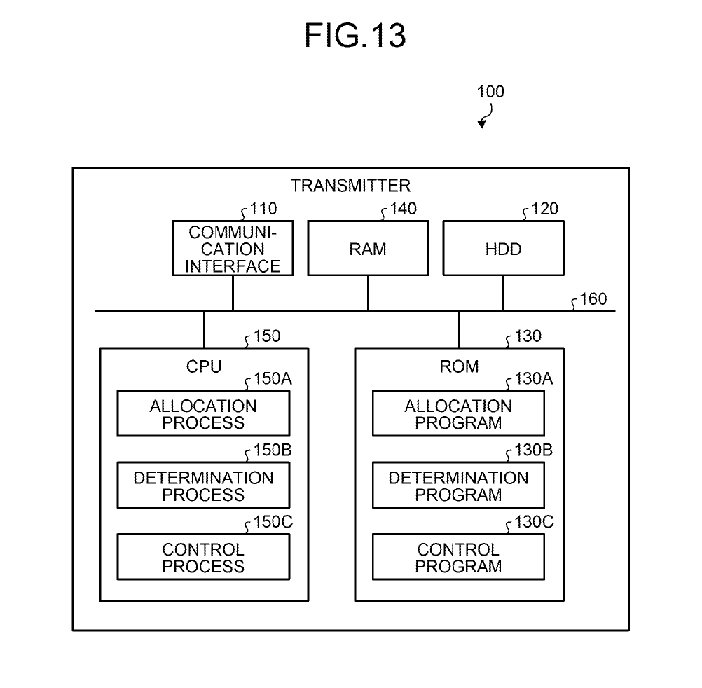

The various types of processing described in the present embodiment are performed by a processor, such as a CPU, in a transmitter executing a computer program provided in advance. The following describes an example of a transmitter that executes a computer program having the same functions as those in the embodiment above. FIG. 13 is an example diagram for explaining a transmitter that executes a transmission program.

A transmitter 100 that executes a transmission program illustrated in FIG. 13 includes a communication interface 110, a hard disk drive (HDD) 120, a read only memory (ROM) 130, a random access memory (RAM) 140, and a CPU 150. The communication interface 110, the HDD 120, the ROM 130, the RAM 140, and the CPU 150 are connected to one another via a bus 160. The ROM 130 stores therein in advance a transmission program that carries out the same functions as those in the embodiment above. The ROM 130 stores therein in advance an allocation program 130A, a determination program 130B, and a control program 130C as the transmission program. The transmission program may be stored not in the ROM 130 but in a recording medium readable by a drive, which is not illustrated. Examples of the recording medium may include a portable recording medium, such as a compact disc read only memory (CD-ROM), a digital versatile disc (DVD), a universal serial bus (USB) memory, and a semiconductor memory, such as a flash memory.

The CPU 150 reads the allocation program 130A from the ROM 130, thereby functioning as an allocation process 150A. The CPU 150 also reads the determination program 130B from the ROM 130, thereby functioning as a determination process 150B. The CPU 150 also reads the control program 130C from the ROM 130, thereby functioning as a control process 150C.

Based on the priorities of a first signal and a second signal received by a single port in the local device, the CPU 150 allocates the band of the port to the signal having a higher priority. The CPU 150 determines whether a local port in the local device or a destination of the local port uses the first signal as a standby in a redundant configuration. When it is determined that the local port or the destination uses the first signal as the standby, the CPU 150 changes the priority of the second signal received by the local port such that the priority of the second signal is higher than that of the first signal. Thus, it is possible to effectively use the physical band.

The present invention can effectively use a physical band.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A transmitter comprising:
an allocating unit that allocates, based on priorities of a first signal and a second signal received by a single port in the transmitter, a band of the port to a signal having a higher priority;
a determining unit that determines whether a local port in the transmitter or a destination of the local port uses the first signal as a standby signal in a redundant configuration; and
a control unit that changes, when the determining unit determines that the local port or the destination uses the first signal as the standby signal, the priority of the second signal received by the local port such that the priority of the second signal is higher than the priority of the first signal.

2. The transmitter according to claim 1, wherein
the control unit changes the priority of the second signal at a previous stage before the local port receives the first signal and the second signal, and
the allocating unit allocates the band of the local port to the first signal and the second signal based on the changed priority.

3. The transmitter according to claim 1, wherein, after the priority of the second signal is changed, and the allocating unit allocates the band of the local port to the first signal and the second signal based on the changed priority, the control unit restores the priority of the second signal to the priority before the change and outputs the second signal.

4. The transmitter according to claim 1, wherein the destination is a port of a destination transmitter opposite to the local port.

5. The transmitter according to claim 4, wherein the determining unit acquires state information indicating a state of the port of the destination transmitter from the destination transmitter and determines whether the port of the destination transmitter uses the first signal as the standby signal based on the state information.

6. A transmission system including a plurality of transmitters and that transmits a first signal and a second signal between the transmitters, wherein
the transmitters each comprise:
an allocating unit that allocates, based on priorities of the first signal and the second signal received by a single port in the transmitter, a band of the port to a signal having a higher priority;
a determining unit that determines whether a local port in the transmitter or a destination of the local port uses the first signal as a standby signal in a redundant configuration; and
a control unit that changes, when the determining unit determines that the local port or the destination uses the first signal as the standby signal, the priority of the second signal received by the local port such that the priority of the second signal is higher than the priority of the first signal.

7. A computer-readable recording medium having stored therein a transmission program, the transmission program causing a transmitter to execute a process comprising:
allocating, based on priorities of a first signal and a second signal received by a single port in the transmitter, a band of the port to a signal having a higher priority;
determining whether a local port in the transmitter or a destination of the local port uses the first signal as an standby signal in a redundant configuration; and
changing, when it is determined that the local port or the destination uses the first signal as the standby signal, the priority of the second signal received by the local port such that the priority of the second signal is higher than the priority of the first signal.
